(19) United States
(12) Patent Application Publication
(10) Pub. No.: US 2016/0279911 A1
(43) Pub. Date: Sep. 29, 2016

(54) PROTECTIVE COMPOSITE MATERIALS

(71) Applicant: Ansell Limited, Richmond (AU)

(72) Inventor: Anna Maria Kristin Geidenmark Olofsson, Skurup (SE)

(21) Appl. No.: 15/077,413

(22) Filed: Mar. 22, 2016

Related U.S. Application Data
(60) Provisional application No. 62/137,265, filed on Mar. 24, 2015.

(51) Int. Cl. B32B 27/12; B32B 27/30; B32B 5/02

(52) U.S. Cl. CPC B32B 27/12; B32B 5/022; B32B 27/304; B32B 2307/3065; B32B 2262/106; B32B 2571/00

(57) ABSTRACT

A protective composite material that includes a first layer that includes at least one of a polychloroprene film or a poly (vinyl chloride) film; a second layer comprising a fabric substrate having at least one of m-aramid fibers and/or p-aramid fibers, disposed on the first layer; and a third layer comprising polychloroprene disposed adjacent to the second layer, wherein the second layer is disposed between the first layer and the third layer. A fourth barrier layer is optionally disposed on the third layer.

### CROSS-REFERENCE TO RELATED APPLICATIONS

This application claims the benefit of priority to U.S. Application No. 62/137,265, filed on Mar. 24, 2015, which is incorporated in its entirety for all purposes.

### BACKGROUND

1. Field of the Invention

Embodiments of the present invention generally relate to multi-layer materials. More specifically, embodiments of the present invention relate to protective composite materials having various barrier properties.

2. Description of the Related Art

Many protective suits are made for service within hazardous environments, such as where harmful biological agents, i.e., viruses, germs, bacteria, etc., are present or where harmful chemicals are present, e.g., during firefighting activities. Protective suits are often made of composite materials consisting of multi-layer laminates. However, protective suits are often specified for one of many barrier properties. For example, barrier properties to protect against different types of chemicals, such as harmful gases or for protection against the penetration of a broad spectrum of chemicals, e.g., polar liquids, non-polar liquids, acidic liquids, or basic liquids. Moreover, protective suits are cleaned for re-use and, during cleaning, are exposed to ozone and ultraviolet light as well as various chemicals. Protective suits also require resistance to physical hazards, such as flame resistance, abrasion resistance and puncture and tear resistance. Furthermore, the barrier properties of the composite materials are lessened when thin and light properties are balanced against barrier and other physical properties.

Composite materials consist of several layers, typically at least four or five, to provide protection from many different types of hazards. Composite materials contain barrier layers disposed between other layers. Barrier layers are often embedded between multiple rubber layers, which produce thick inflexible composite materials, typically consisting of surface weights of greater than 800 g/m². To date, no protective suit is capable of protecting against several types of hazards while remaining thin and light.

With the foregoing in view, protective composite materials capable of providing barriers to germs, viruses, many chemicals, punctures, abrasions, and the like, as well as ozone, moisture, ultraviolet light, for manufacturing thin, flexible, light garments, such as protective suits, represent advances in the art.

### SUMMARY

Protective, composite materials, substantially as shown in and/or described in connection with at least one of the figures, as set forth more completely in the claims, are disclosed. Various advantages, aspects, and novel features of the present disclosure, as well as details of exemplary embodiments thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings and disclosure depict exemplary embodiments of the invention and are therefore not to be considered limiting of the scope of the particular forms described, for those skilled in the art will recognize additional embodiments of the present invention, which covers all modifications, equivalents, and alternatives within the spirit and scope of the present invention as defined by the appended claims.

FIG. 1 depicts a perspective view of a protective suit comprising a protective composite material, according to embodiments of the invention;

FIG. 2 depicts a cross-section taken along line 2-2 of the protective composite material of FIG. 1, according to embodiments of the invention;

FIG. 3 depicts a close up view of the protective composite material of FIG. 2, according to embodiments of the invention;

FIG. 4 depicts a close up view of an alternative embodiment of a cross-section of the protective composite material of FIG. 2, according to embodiments of the invention;

FIG. 5 depicts a second alternative close up view of a cross-section of the protective composite material of FIG. 2, according to embodiments of the invention; and

FIG. 6 depicts a close up view of the cross-section of a fourth layer of the protective composite material of FIG. 2, according to embodiments of the invention.

The headings used herein are for organizational purposes only and are not meant to be used to limit the scope of the description or embodiments according to the invention. As used throughout this application, the word “may” is used in a permissive sense, meaning having the potential to, rather than a mandatory sense. Similarly, the words “include,” “including,” and “includes” mean including, but not limited to.

### DETAILED DESCRIPTION

Embodiments according to the present invention include protective composite materials comprising at least three or optionally four layers adhered together, which can be used to manufacture garments, for example, protective suits. At least one embodiment according to the invention includes a plurality of layers, including an outer layer, a substrate layer, and an inner layer, and optionally at least one barrier layer disposed on the inner layer. Also, at least one exemplary embodiment includes wherein the outer layer comprises a poly (vinyl chloride) layer, that is optionally flame retardant, a woven or non-woven substrate layer having at least one of m-aramid fibers and/or p-aramid fibers, and a polychloroprene layer disposed as the inner layer. At least one exemplary embodiment according to the invention, for example, comprises a barrier layer that further comprises a polyethylene layer, an ethylene vinyl alcohol layer, and a polyamide layer. Embodiments of the present invention provide vastly lighter garments, i.e., layered composite materials for garments disclosed herein have surface weights of approximately 465 g/m²-780 g/m².

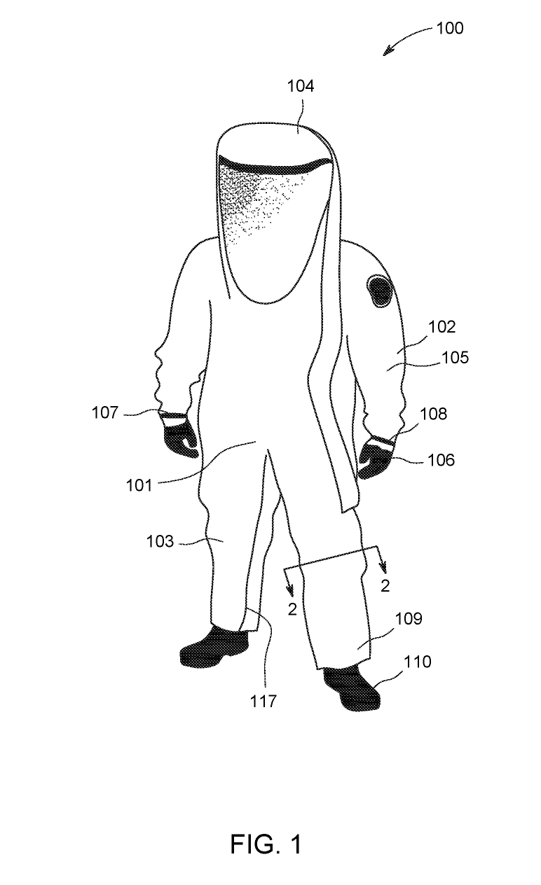

FIG. 1 depicts a perspective view of a protective suit 100 comprising a protective composite material 102, according to embodiments of the present invention. The protective suit 100 comprises a hood 104, a body portion 101, leg portions 103, arm portions 105, gloves 106 at a distal arm end 107 of the arm portions 105, and glove mounts 108 at the distal arm end 107. Some embodiments of the invention optionally comprise feet 110 at a distal leg end 109. The glove mounts 108 are integrally attached to the distal arm end 107. In this context, integrally attached means that the glove mounts 108 cannot be separated from the distal arm ends 107 without destroying the gloves 106 or distal arm ends 107. In at least one embodiment of the invention, the glove mounts 108 are releasably attached to the gloves 106 of the protective suit 100, for example, bayonet-style mounts as are known to those in the art or, for example, a glove attachment system comprising a ring having internal grooves and an open-ended conical member having external ribs for engaging the internal grooves of the ring, either of which may comprise a compliant and resilient material.

As described in greater detail below, the protective composite material 102 comprises, for example, at least one fabric layer and at least one barrier layer, as described further below, and is manufactured by, for example, lamination processes, such as extrusion lamination or dry lamination or a blown film process. Alternatively, as is discussed further below, the protective composite material 102 may be manufactured in one or more blown film steps.

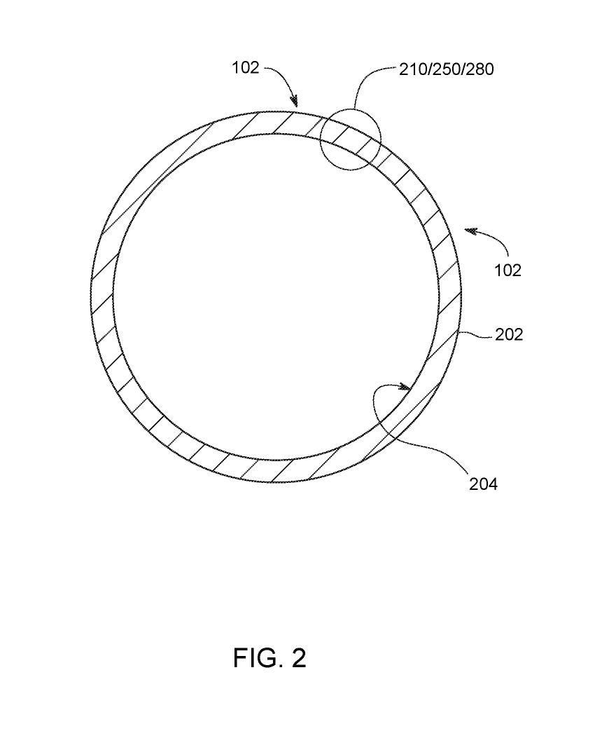

FIG. 2 depicts a cross-sectional view taken along line 2-2 of the protective composite material 102 of FIG. 1, according to embodiments of the invention. The cross-sectional view of protective composite material 102 comprises an external surface 202 and an internal surface 204, which may be a skin-contacting surface. A wall thickness of the protective composite material 102 is, for example, approximately 450-1440 microns and surface weights of 465 g/m²-780 g/m².

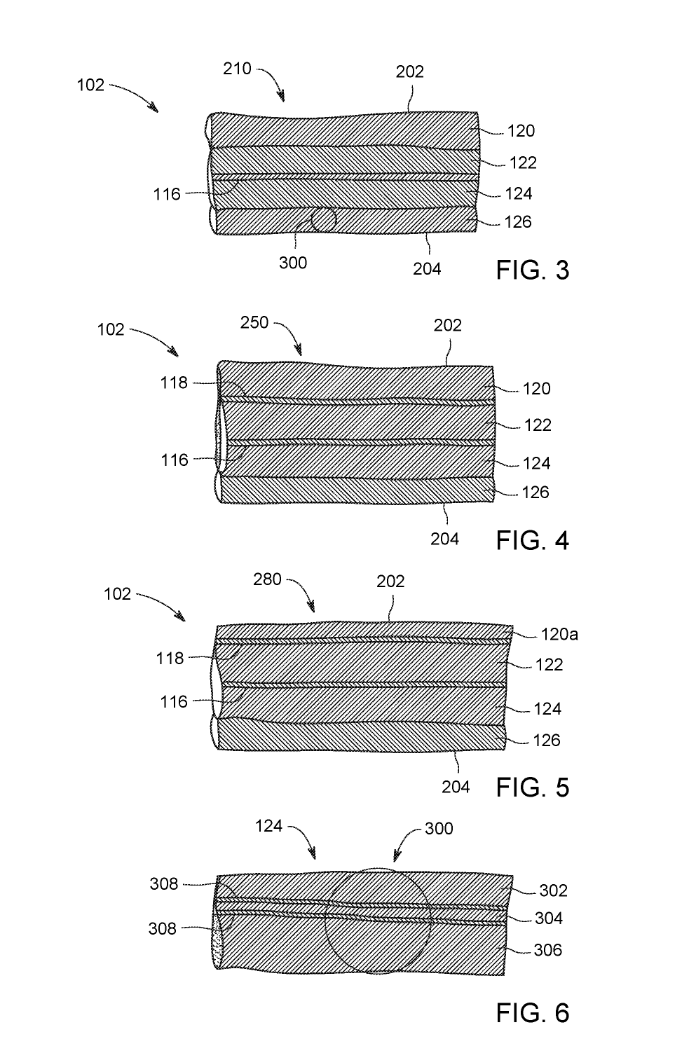

FIG. 3 depicts a close up view 210 of the protective composite material 102 of FIG. 2, according to embodiments of the present invention. The protective composite material 102 comprises, for example, a three layer or optionally a four layer composite material, including a first layer, such as an outer (which has an external surface 202), a second layer—a middle layer 122, which is a substrate layer, a third layer—an inner layer 124, and optionally, a fourth layer 126, which is a barrier layer. Also, either the inner layer 124 or the fourth layer 126 would be disposed closest to the skin of a wearer of a protective suit manufactured using the composite material 102. The outer layer 120 is a film or sheet and may be produced offline or sourced. For example, at least one embodiment of the outer layer 120 comprises polyvinyl chloride (PVC), which may be a flame-retardant or a non-flame-retardant PVC, polychloroprene, thermoplastic polyurethane (TPU), thermoplastic elastomers, and/or thermoplastic polyolefins. In at least one exemplary embodiment of the invention, the outer layer 120 comprises a flame-retardant soft PVC film, which is manufactured by, for example, one or more of calendaring, cast, blown film, or spreading (plastisol, solvent based solutions, two-component systems, etc.) processes as are known to those in the art. Also, at least one embodiment of the present invention comprises wherein the outer layer 120 is a calendared flame-retardant soft PVC film that ranges from approximately 170-340 microns in thickness and a surface weight ranging from approximately 200-500 g/m².

The middle layer 122, a substrate layer, such as a fabric substrate, comprises, for example, at least one of p-aramid fibers, m-aramid fibers, glass fibers, metal fibers, carbon fibers, polyimide, polybenzimidizole, poly (phenylene benzobisoxazole), melamine formaldehyde fibers, novoloid, polyphenylene sulphide, oxidized acrylic fibers, polytetrafluoroethylene (PTFE) fibers, ceramic fibers, PVC or poly (vinylidene chloride) (PVDC) fibers or any blend or mixture thereof, any of which comprises flame-retardant fibers. In at least one exemplary embodiment of the invention, the middle layer 122 comprises a non-woven felt, for example, a needle felt non-woven felt randomly distributed as a fiber mixture having, for example, 35% p-aramid fibers and 65% m-aramid fibers, which is approximately 800-1200 microns thick and ranges in surface weight from approximately 80-150 g/m² and may be calendered. The middle layer 122 may further comprise approximately 0-2% carbon fibers.

The inner layer 124 comprises at least one of various materials, such as biaxially oriented polypropylene (BOPP), polypropylene (PP), various polyethylenes, such as low density polyethylene (LDPE), high density polyethylene (HDPE), linear low density polyethylene (LLDPE), ultra-low density polyethylene (ULDPE), such as ATTANE® resins marketed by the Dow Chemical Co., and/or QUOE®, marketed by Borealis AG, CLEARFLEX®, marketed by Polimeri Europa and TEAMEX®, marketed by DSM Corp., all generally having a surface weight of approximately 28-60 g/cm², which is proportional to density; metallocene polyethylenes, or branched polyethylenes, nylons/polyamides, such as nylon 46, nylon 66, nylon 6, or nylon 12, ethylene vinyl alcohol (EVOH), ethylene vinyl acetate (EVA), PVC, PVDC, poly (ethylene terephthalate) (PET), various fluoropolymers, various chlorinated and/or fluorinated polyethylenes, and various co-polymer materials and metals, such as aluminum films or metalized polymeric films. In at least one exemplary embodiment according to the invention, the inner layer 124 comprises at least one of a flame retardant polychloroprene film, a flame retardant poly (vinyl chloride) film, or a flame retardant chlorinated polyethylene film. Also, at least one exemplary embodiment of the inner layer 124 ranges from approximately 75-100 microns in thickness and surface weights of approximately 75-100 g/m². A first adhesive 118 and a second adhesive 116, according to embodiments of the invention, comprise acrylic adhesives, hot melt adhesives, such as polyethylene or butyl-based hot melt adhesives, or elastomers and are generally 1-3 microns in thickness. The first adhesive 118 and/or a second adhesive 116 in at least one exemplary embodiment of the invention comprises a solvent-based polychloroprene elastomer that is, optionally, partially crosslinked and has a surface weight of approximately 25 g/m².

In at least one exemplary embodiment according to the invention, the fourth layer 126, discussed further below, comprises three layers and an adhesive disposed between adjacent layers. At least one exemplary embodiment of the fourth layer 126 comprises a polyamide having a thickness of approximately 15-30 microns, a polyurethane adhesive, an EVOH film having a thickness of approximately 4-5 microns, a polyurethane adhesive, and a polyethylene layer having a thickness of approximately 31-65 microns, wherein a barrier layer of approximately 50-100 microns in thickness is produced.

The inner layer 124 can be produced by, for example, a blown film extrusion or cast extrusion or a combination of both for adhering or laminating the layers of the inner layer (discussed below) with each other. Multiple layers can be laminated, for example, three to nine layers. The inner film 124, according to embodiments of the invention, comprises a blown film in which five extruders, operating at a temperature range of approximately 100-300° C. and a linear speed of, for example, 30-130 m/min, blow five layers to form the inner film 124. Extrusion lamination comprises extruding a molten polymeric layer, which adheres and penetrates another layer, for e.g., a substrate and may include an adhesive, e.g., the first adhesive 118 and/or the second adhesive 116 and other adhesives disclosed herein, disposed between the polymeric layer and substrate, which is pressed between at least two nip rollers. Examples of other adhesives comprise polyurethane dispersions, acrylic emulsions, acrylic solvents, water-based polyvinyl alcohols, ethylene vinyl acetate copolymers, high solids silicone solvents, modified polyolefins, polyesters, rubbers, starches, dextrins, latexes, and one or two component polyurethanes with ester or ketone solvents, or 100% solids polyurethanes. The protective suit 100 can, optionally, be manufactured by joining pieces of the protective composite material at seams 117 using, for example, heat sealed tapes and/or ribbons as are known to those in the art.

Dry lamination processes comprise the use of an adhesive applied to either or both of a layer, such as a polymeric film, or a substrate, such as a fabric substrate, pressing the layer and the substrate together between nip rollers, for example, at 5-20 MPa and temperatures ranging from approximately 60-150° C. and roll speeds of, for example, 5-50 m/minute and driving off a solvent within the adhesive, as is known to those in the art. Composite materials according to embodiments of the invention having a plurality of layers can be made by repeating lamination processes to incorporate additional layers, as discussed below.

The outer layer 120 and the middle layer 122 may be bonded by a lamination process, such as dry lamination processes as are known to those in the art. Dry lamination, without the use of an adhesive, comprises either band or flat-bed lamination through heat, for example, 120-300° C. and pressure, 0.5-0.6 MPa, which press and melt thermoplastic or elastomeric film (i.e., the outer layer 120 and the middle layer 122, either or both of which comprise thermoplastics materials) together without an adhesive, for a duration of time, for example, 5-45 minutes. At least one exemplary embodiment includes a band lamination step at approximately 160° C., a speed of approximately 100 m/h, and a pressure of approximately 0.5 MPa, for adhering the PVC film of the outer layer 120 to the non-woven substrate (comprising m-aramid fibers and/or p-aramid fibers mixed within a non-woven fabric) of the middle layer 122. Alternatively, calendaring temperatures of the flame-retardant soft PVC film, such as the outer layer 120, range from 150-280° C. and at a speed of approximately 30-100 m/min. A second adhesive 116, such as a solvent based chloroprene adhesive, is applied, for example, by spreading, onto the middle layer 122, approximately 1-3 microns thick. The inner layer 124 and/or the fourth layer 126 is cold laminated thereto via, for example, roll to roll processes, wherein the second adhesive 116 is disposed between the inner layer 124 and the middle layer 122 and/or the fourth layer 126.

FIG. 4 depicts a close up view 250 of a first alternative protective composite material 102 of FIG. 2, according to embodiments of the present invention. The first alternative protective composite material 102 comprises, for example, an outer layer 120, a middle layer 122, which is a substrate layer, and an inner layer 124, and the fourth layer 126, a barrier layer, which may be a skin-contacting layer. A first adhesive 118 is disposed between the outer layer 120 and the middle layer 122. A second adhesive 116 is disposed between the middle layer 122 and the inner layer 124. The first adhesive 118 and/or the second adhesive 116 may be disposed between the inner layer 124 and the fourth layer 126. The first adhesive 118 and the second adhesive 116 may comprise a polychloroprene layer, having a surface weight of approximately 25 g/m². The thickness of the alternative cross section 250, comprising the outer layer 120, the first adhesive 118, the middle layer 122, the second adhesive 116, and the inner layer 124, ranges from approximately 550 to 970 microns and comprises surface weights ranging from approximately 385-720 g/m².

The outer layer 120 comprises a film, for example, a film comprising a polychloroprene, a chloro-sulphonated polyethylene, a chlorinated polyethylene, an ethylene acrylic elastomer, an epichlorohydrin, fluorinated elastomers, a butyl elastomer, a styrene-ethylene-styrene thermoplastic elastomer, a thermoplastic polyurethane, a urethane elastomer, or a silicone elastomer, or combinations thereof. In at least one exemplary embodiment of the invention, the outer layer 120 is a flame retardant polychloroprene film having a surface weight of approximately 170-400 gm² and ranges from approximately 150-300 microns in thickness. Furthermore, at least one exemplary embodiment of the invention comprises a film having a flame retardant polychloroprene and a polyurethane elastomer.

The middle layer 122, a substrate layer, such as a fabric substrate, comprises, for example, at least one of p-aramid fibers, m-aramid fibers, glass fibers, metal fibers, polyimide, polybenzimidizole, poly (phenylene benzobisoxazole), melamine formaldehyde fibers, novoloid, polyphenylene sulphide, oxidized acrylic fibers, polytetrafluoroethylene (PTFE) fibers, ceramic fibers, PVC or poly (vinylidene chloride) (PVDC) fibers or any blend or mixture thereof, any of which comprises flame-retardant fibers. In at least one exemplary embodiment of the invention, the middle layer 122 comprises a non-woven felt, for example, a needle felt non-woven felt randomly distributed as a fiber mixture having, for example, 35% p-aramid fibers and 65% m-aramid fibers, which is approximately 800-1200 microns thick and ranges in surface weight from approximately 80-150 g/m² and may be calendered. The middle layer 122 may further comprise approximately 0-2% carbon fibers. In at least one exemplary embodiment of the invention, the middle layer 122 comprises a plain woven, i.e., rapier mill weave, or non-woven fabric substrate having m-aramid staple fibers, and is approximately 300-400 microns thick and ranges from 130-150 g/m² in surface weight.

The inner layer 124 comprises at least one of various materials, such as biaxially oriented polypropylene (BOPP), polypropylene (PP), various polyethylenes, such as low density polyethylene (LDPE), high density polyethylene (HDPE), linear low density polyethylene (LLDPE), ultra-low density polyethylene (ULDPE), metallocene polyethylenes, or branched polyethylenes, nylons/polyamides, such as nylon 46, nylon 66, nylon 6, or nylon 12, ethylene vinyl alcohol (EVOH), ethylene vinyl acetate (EVA), PVC, PVDC, poly (ethylene terephthalate) (PET), various fluoropolymers, various chlorinated and/or fluorinated polyethylenes, and various co-polymer materials and metals, such as aluminum films or metalized polymeric films. At least one exemplary embodiment of the inner layer 124 comprises, for example, three layers having any combination of the above materials, having a first adhesive 118, or a second adhesive 116 between each of the three layers, as discussed further below. The adhesives 116, 118, according to embodiments of the invention, include acrylic adhesives, hot melt adhesives, such as polyethylene or butyl-based hot melt adhesives, or elastomers, such as thermoplastic rubbers or thermoplastic olefins and, as above, are generally 1-3 microns in thickness. The first adhesive 118 and the second adhesive 116 in at least one exemplary embodiment of the invention comprise a solvent-based polychloroprene elastomer, which is optionally partially crosslinked, having a surface weight of approximately 90 g/m².

In at least one exemplary embodiment according to the invention, the second adhesive 116, such as a solvent-based polychloroprene, is spread, e.g., a knife over roll spreading, which is optionally repeated for multiple coatings of a solvent-based polychloroprene, for example, three coatings, on the middle layer 122. The second adhesive 116, according to embodiments of the invention, is optionally applied in-line through a transfer from a carrier material, inline coating of a hot melted adhesive, or in a separate spreading line, where a solvent based adhesive is applied and a solvent(s) is extracted thereafter. At least one exemplary embodiment of the invention comprises a solvent-based spreading of polychloroprene, having solvents that may be evaporated at heats ranging from approximately 100-180° C.

The inner layer 124 and the middle layer 122 are bonded by lamination processes, such as blown film, extrusion lamination, or dry lamination processes as are known to those in the art, wherein the second adhesive 116 is disposed between the inner layer 124 and the middle layer 122. The middle layer 122 and the inner layer 124 are adhered to the outer layer 120, which has the first adhesive 118 disposed thereon, so that the first adhesive 118 is disposed between the middle layer 122 and the outer layer 120. At least one exemplary embodiment includes wherein the middle layer 122 and the outer layer 120 are adhered via a band lamination process at approximately 160° C., at a speed of approximately 100 m/h, and a pressure of approximately 0.5-0.6 MPa, for adhering the first adhesive 118 of the outer layer 120 to the non-woven substrate of the middle layer 122. Optionally, in at least one exemplary embodiment according to the invention, the fourth layer 126, as above, comprises three layers and an adhesive disposed between adjacent layers, e.g., the fourth layer 126 comprises a polyamide having a thickness of approximately 15-30 microns, a polyurethane adhesive, an EVOH film having a thickness of approximately 4-5 microns, a polyurethane adhesive, and a polyethylene layer having a thickness of approximately 31-65 microns, which may be adhered to the inner layer 124 using dry lamination and/or blown film extrusion processes as discussed herein.

FIG. 5 depicts a close up view 280 of a second alternative embodiment of a cross-section of the protective composite material 102 of FIG. 2, according to embodiments of the invention. The protective composite material 102 comprises, for example, an additional adhesive within the protective composite material 102 that, as above, comprises an outer layer 120a, the middle layer 122, which is a substrate layer, and the inner layer 124. The outer layer 120a comprises a film, for example, a film comprising a polychloroprene, a chloro-sulphonated polyethylene, a chlorinated polyethylene, an ethylene acrylic elastomer, an epichlorohydrin, fluorinated elastomers, a butyl elastomer, a styrene-ethylene-styrene thermoplastic elastomer, a thermoplastic polyurethane, a urethane elastomer, or a silicone elastomer, or combinations thereof.

In at least one exemplary embodiment of the invention, the outer layer 120a is a calendared flame retardant chlorinated polyethylene film having a surface weight of approximately 100-200 gm² and comprises an outer layer 120a that is thinner compared with the outer layer 120 of the protective composite materials in close up views 210 and 250 and ranges from approximately 100-200 microns in thickness. In at least one exemplary embodiment according to the invention, the second alternative comprises the fourth layer 126, as discussed above, adhered to the inner layer 124. As above, the fourth layer 126 comprises a polyamide having a thickness of approximately 15-30 microns, a polyurethane adhesive, an EVOH film having a thickness of approximately 4-5 microns, a polyurethane adhesive, and a polyethylene layer having a thickness of approximately 31-65 microns and may be adhered to the inner layer 124 using dry lamination and/or blown film extrusion processes as discussed herein.

The thickness of the alternative cross section 250, comprising the outer layer 120a, the second adhesive 116, the middle layer 122, the first adhesive 118, and the inner layer 124, ranges from approximately 450 to 820 microns and has a surface weight ranging from approximately 325-615 g/m². The outer layer 120a of the second alternative, which comprises the flame-retardant chlorinated polyethylene, further comprises, for example, a flame-retardant chlorinated polyethylene that is NFPA 1991 certified.

Table 1 lists one exemplary formula for the outer layer 120a, which includes anti-oxidants, such as a polymerized 2,2,4-trimethyl-1,2-dihydroquinoline (TMQ), 2-mercaptobenzimidazole (MBI), tris(nonylphenyl) phosphite; fillers, such as silica, kaolin, carbon black, including conductive carbon black, and/or other fillers known to those in the art; softeners and plasticizers, e.g., caprylates, such as methyl caprylate, dibutyl adipate (DBA), and/or dioctyl adipate (DOA); flame retardants, such as trioctyl phosphate, aluminum hydroxide, antimony trioxide, zinc borate, and/or others known to those in the art; curing systems, such as magnesium oxide, and/or peroxides or di-functional peroxides, e.g., di(tert-butylperoxyisopropyl) benzene, vinyl-silanes, peroxide initiators; and/or colorants, such as titanium dioxide and/or other colorants.

TABLE 1
Component

| | PHR |
|---|---|
| Chlorinated polyethylene, chlorine content 30-45% | 100 |
| Antioxidant | 1.5-3 |
| Fillers | 40-70 |
| Softener | 15-30 |
| Flame retardant | 3-24 |
| Curing system(s) | 2-10 |
| Colorant(s) | 5-20 |
| Initiator(s) | 2-8 |

The middle layer 122, a substrate layer, such as a fabric substrate, comprises, for example, at least one of p-aramid fibers, m-aramid fibers, glass fibers, metal fibers, polyimide, polybenzimidizole, poly (phenylene benzobisoxazole), melamine formaldehyde fibers, novoloid, polyphenylene sulphide, oxidized acrylic fibers, polytetrafluoroethylene (PTFE) fibers, ceramic fibers, PVC or poly (vinylidene chloride) (PVDC) fibers or any blend or mixture thereof, any of which comprises flame-retardant fibers. In at least one exemplary embodiment of the invention, the middle layer 122 comprises a mix of p-aramid and/or m-aramid fibers and carbon fibers approximately every 10 rows or courses, which may be a knitted, woven, or non-woven substrate. Also, in at least one exemplary embodiment of the invention, the middle layer 122 comprises a plain weave, twill weave, or needle-felted non-woven, further comprising 68% m-aramid, 30% p-aramid, and 2% carbon fibers, having a surface weight of 125-145 g/m² and is approximately 250-350 microns thick.

The inner layer 124, as above, comprises various materials, such as at least one of biaxially oriented polypropylene (BOPP), polypropylene (PP), various polyethylenes, such as low density polyethylene (LDPE), high density polyethylene (HDPE), linear low density polyethylene (LLDPE), ultra-low density polyethylene (ULDPE), metallocene polyethylenes, or branched polyethylenes, nylons/polyamides, such as nylon 46, nylon 66, nylon 6, or nylon 12, ethylene vinyl alcohol (EVOH), ethylene vinyl acetate (EVA), PVC, PVDC, poly (ethylene terephthalate) (PET), various fluoropolymers, various chlorinated and/or fluorinated polyethylenes, and various co-polymer materials and metals, such as aluminum films or metalized polymeric films. The inner layer 124 may further comprises, for example, two to three layers having any combination of the above materials.

The outer layer 120a is, for example, a calendared film, comprising at least one of a polychloroprene, a chloro-sulphonated polyethylene, a chlorinated polyethylene, an ethylene acrylic elastomer, an epichlorohydrin, fluorinated elastomers, such as fluorinated polyethylenes, a butyl elastomer, one or more styrene-ethylene-styrene thermoplastic elastomers, one or more thermoplastic polyurethanes, a urethane elastomer, or a silicone elastomer, or combinations thereof.

At least one exemplary embodiment according to the invention comprises an outer layer 120a further comprising a flame-retardant chlorinated polyethylene film having a surface weight of approximately 100-200 g/m². The middle layer 122 has the first adhesive 118, for example, a polychloroprene material, spread thereon to promote adhesion. The outer layer 120a may be calendared directly onto the middle layer 122 having the first adhesive 118 disposed thereon or, alternatively, onto a carrier material (not shown) as known to those in the art and calendared with the middle layer 122. Thereafter, the middle layer 122 and the outer layer 120a are cured via a band cure line at a temperature ranging from 120-300° C. For at least one embodiment, the middle layer 122 and the outer layer 120a are cured at approximately 140° C. and 0.5 MPa in a band lamination process as described above.

As above, at least one exemplary embodiment comprises the fourth layer 126 which further comprises a polyamide having a thickness of approximately 15 microns, a polyurethane adhesive, an EVOH film having a thickness of approximately 4 microns, a polyurethane adhesive, a polyethylene layer having a thickness of approximately 31 microns, producing a barrier layer of approximately 50 microns in thickness. Embodiments of the invention further comprise wherein the fourth layer 126 ranges from approximately 20-70 microns in thickness and 20-70 g/m².

FIG. 6 depicts a close up view 300 of the cross-section of the fourth layer 126 of the protective composite material 102 of FIG. 2, according to embodiments of the invention. The fourth layer 126, which is a barrier layer, comprises various materials, such as at least one of a biaxially oriented polypropylene (BOPP), polypropylene (PP), various polyethylenes, such as low density polyethylene (LDPE), high density polyethylene (HDPE), linear low density polyethylene (LLDPE), ultra-low density polyethylene (ULDPE), metallocene polyethylenes, or branched polyethylenes, nylons/polyamides, such as nylon 46, nylon 66, nylon 6, or nylon 12, ethylene vinyl alcohol (EVOH), ethylene vinyl acetate (EVA), PVC, PVDC, poly (ethylene terephthalate) (PET), various fluoropolymers, various chlorinated and/or fluorinated polyethylenes, and various co-polymer materials and metals, such as aluminum films or metalized polymeric films.

The fourth layer 126 comprises, for example, three layers having of any combination of the above materials, having an adhesive disposed between each adjacent layer. At least one exemplary embodiment of the fourth layer 126 comprises a first barrier layer 302 comprising a polyamide having a thickness of approximately 10-20 microns, a polyurethane adhesive 308, a second barrier layer 304 comprising an EVOH film having a thickness of approximately 4-6 microns, a polyurethane adhesive 308, and a third barrier layer 306 comprising a polyethylene layer having a thickness of approximately 31-65 microns, producing a fourth layer 126 ranging from approximately 50 microns to approximately 101 microns. At least one exemplary embodiment according to the invention comprises a fourth layer 126 of approximately 50 microns in thickness.

Embodiments according to the invention further provide a protective composite material, that comprises a first layer comprising at least one of a polychloroprene film, a poly (vinyl chloride) film, or a chlorinated polyethylene film; a second layer comprising a substrate disposed on the first layer; and a third layer comprising a polychloroprene film disposed adjacent to the second layer, wherein the second layer is disposed between the first layer and the third layer.

In some exemplary embodiments of the protective composite material described above, a flame-retardant poly (vinyl chloride) film is provided.

In some exemplary embodiments, a barrier layer disposed on the third layer is provided and may be incorporated into any of the foregoing protective composite materials described above.

In some exemplary embodiments of any of the protective composite materials described above a barrier layer that comprises a polyamide film, an EVOH film, and a polyethylene film is provided and may be incorporated into any of the foregoing protective composite materials described above. Any barrier layer described herein is optionally processed via blown film processes, wherein a polychloroprene adhesive and/or a polyurethane adhesive is disposed between the polyamide film, the EVOH film, and the polyethylene film and is approximately 30-100 microns in thickness.

Embodiments of any of the protective composite materials described above further comprise wherein the first layer further comprises a chloro-sulphonated polyethylene, an ethylene acrylic elastomer, an epichlorohydrin, fluorinated elastomers, a butyl elastomer, a styrene-ethylene-styrene thermoplastic elastomer, a thermoplastic polyurethane, a urethane elastomer, or a silicone elastomer, or combinations thereof.

Embodiments of any of the protective composite materials described above further comprise wherein the second layer comprises at least one of a needle-felted, plain weave, or twill aramid material and may be incorporated into any of the foregoing protective composite materials described above.

In some exemplary embodiments of any of the protective composite materials described above, a second layer, e.g., a substrate layer, is a woven, non-woven, or needle-felted non-woven substrate layer, and comprises meta-aramid fibers and/or p-aramid fibers within the substrate layer and may be incorporated into any of the foregoing protective composite materials described above.

Embodiments of any of the protective composite materials described above further comprise wherein the second layer further comprises p-aramid fibers, m-aramid fibers, glass fibers, metal fibers, polyimide, polybenzimidizole, poly (phenylene benzobisoxazole), melamine formaldehyde fibers, novoloid, polyphenylene sulphide, oxidized acrylic fibers, carbon fibers, polytetrafluoroethylene fibers, ceramic fibers, poly (vinyl chloride) or poly (vinylidene chloride) fibers or a blend or mixture thereof.

In some exemplary embodiments of any of the protective composite materials described above a second layer comprising approximately 30-35% p-aramid, 65-70% m-aramid, and 0-2% carbon fibers is provided and may be incorporated into any of the foregoing protective composite materials described above.

Embodiments of any of the protective composite materials described above further comprise wherein the third layer comprises biaxially oriented polypropylene, polypropylene, low density polyethylene, high density polyethylene, linear low density polyethylene, ultra-low density polyethylene, metallocene polyethylenes, branched polyethylenes, chlorinated and/or fluorinated polyethylenes, nylon 46, nylon 66, nylon 6, nylon 12, ethylene vinyl alcohol, ethylene vinyl acetate, poly (vinyl chloride), poly (vinylidene chloride), poly (ethylene terephthalate), fluoropolymers, or metalized polymeric films, or blends or combinations thereof.

In some exemplary embodiments of any of the protective composite materials described above further comprise wherein a solvent based chloroprene adhesive is disposed between the first layer and the second layer and between the second layer and the third layer.

In some exemplary embodiments of any of the protective composite materials described above, at least one of a polyurethane adhesive or a polychloroprene adhesive is disposed between the polyamide film and the EVOH film is provided and may be incorporated into any of the foregoing protective composite materials described above.

In some exemplary embodiments of any of the protective composite materials described above further comprise wherein at least one of a polyurethane adhesive or a polychloroprene adhesive is disposed between the EVOH film and the polyethylene film and may be incorporated into any of the foregoing protective composite materials described above.

Embodiments of any of the protective composite materials described above further comprise wherein at least one of the polychloroprene of the first layer or the third layer is a partially cross-linked polychloroprene film and may be incorporated into any of the foregoing protective composite materials described above.

Embodiments of any of the protective composite materials described above further comprise wherein a polychloroprene adhesive is disposed between the first layer and the second layer and may be incorporated into any of the foregoing protective composite materials described above.

Embodiments of any of the protective composite materials described above further comprise wherein a solvent-based polychloroprene adhesive is disposed between the first layer and the second layer and may be incorporated into any of the foregoing protective composite materials described above.

Embodiments of any of the protective composite materials described above further comprise wherein at least one of the third layer or the barrier layer is a skin-contacting layer.

At least one exemplary protective composite material, according to embodiments of the invention described above, comprise wherein the outer layer is a flame-retardant PVC layer adhered to a needle-felted substrate layer comprising a mixture of m-aramid and p-aramid fibers, which is adhered to a polychloroprene layer, which is adhered to a barrier layer that comprises a polyamide film adhered to an EVOH film, and a polyethylene film.

At least one exemplary protective composite material, according to embodiments of the invention described above, comprise wherein the outer layer is a polychloroprene layer, which is optionally a flame-retardant polychloroprene layer adhered to a needle-felted substrate layer comprising at least one of m-aramid fibers and/or p-aramid fibers, which is adhered to a polychloroprene layer, which is adhered to a barrier layer that comprises a polyamide film adhered to an EVOH film, and a polyethylene film.

At least one exemplary protective composite material, according to embodiments of the invention described above, comprise wherein the outer layer is a flame-retardant chlorinated polyethylene layer adhered to a substrate layer, such as a needle-felted non-woven substrate layer comprising a mixture of m-aramid fibers, p-aramid fibers, and carbon fibers, which is adhered to a polychloroprene layer with one or more adhesive layers, such as polychloroprene and/or polyurethane adhesives, wherein the polychloroprene layer is adhered to a barrier layer that comprises a polyamide film adhered to an EVOH film, and a polyethylene film.

Embodiments of any of the protective composite materials described above further comprise wherein the protective composite material has a surface weight of approximately 465 g/m² to approximately 780 g/m².

Although only a few exemplary embodiments of the present invention have been described in detail above, those skilled in the art will readily appreciate that many modifications are possible in the exemplary embodiments without materially departing from the novel teachings and advantages of this invention.

All ranges recited herein include ranges therebetween, and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4 . . . 1.1, 1.2, and the like, as well as 1, 2, 3 and the like; if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4 or more, or 3.1 or more.

Publications and references, including but not limited to patents and patent applications, cited in this specification are herein incorporated by reference in their entirety and cited as if each individual publication or reference were specifically and individually indicated to be incorporated by reference herein as being fully set forth.

The foregoing description of embodiments of the invention comprises a number of elements, devices, machines, components and/or assemblies that perform various functions as described. These elements, devices, machines, components and/or assemblies are exemplary implementations of means for performing their respectively described functions. While the foregoing is directed to embodiments of the present invention, other and further embodiments of the invention may be devised without departing from the basic scope thereof.

What is claimed is:

1. A protective composite material, comprising:
a first layer comprising at least one of a flame retardant polychloroprene film, a flame retardant poly (vinyl chloride) film, or a flame retardant chlorinated polyethylene film;
a second layer comprising a non-woven fabric substrate, wherein the fabric substrate comprises a mix of m-aramid fibers and p-aramid fibers;
a third layer comprising a polychloroprene film disposed adjacent to the second layer, wherein the second layer is disposed between the first layer and the third layer and adhered thereto by at least one adhesive; and a barrier layer adhered to the third layer.

2. The protective composite material of claim 1, wherein the barrier layer comprises a polyamide film, an EVOH film, and a polyethylene film, wherein the EVOH film is disposed between the polyamide film and the polyethylene film.

3. The protective composite material of claim 2, wherein the barrier layer is adhered to the third layer via adhesion with the polyamide film.

4. The protective composite material of claim 2, wherein the barrier layer is approximately 50 microns in thickness.

5. The protective composite material of claim 1, wherein the fabric substrate is a needle felted substrate.

6. The protective composite material of claim 1, wherein the fabric substrate is at least one of a plain weave or twill m-aramid material.

7. The protective composite material of claim 1, wherein the fabric substrate comprises 30-35% p-aramid, 65-70% m-aramid, and 0-2% carbon fiber.

8. The protective composite material of claim 1, wherein the fabric substrate further comprises glass fibers, metal fibers, polyimide, polybenzimidizole, poly (phenylene benzobisoxazole), melamine formaldehyde fibers, novoloid, polyphenylene sulphide, oxidized acrylic fibers, carbon fibers, polytetrafluoroethylene fibers, ceramic fibers, carbon fibers, poly (vinyl chloride) or poly (vinylidene chloride) fibers or a blend or mixture thereof.

9. The protective composite material of claim 1, wherein the first layer further comprises a chloro-sulphonated polyethylene, an ethylene acrylic elastomer, an epichlorohydrin, fluorinated elastomers, a butyl elastomer, a styrene-ethylene-styrene thermoplastic elastomer, a thermoplastic polyurethane, a urethane elastomer, or a silicone elastomer, or combinations thereof.

10. The protective composite material of claim 1, wherein the third layer comprises biaxially oriented polypropylene, polypropylene, low density polyethylene, high density polyethylene, linear low density polyethylene, ultra-low density polyethylene, metallocene polyethylenes, branched polyethylenes, chlorinated and/or fluorinated polyethylenes, nylon 46, nylon 66, nylon 6, nylon 12, ethylene vinyl alcohol, ethylene vinyl acetate, poly (vinyl chloride), poly (vinylidene chloride), poly (ethylene terephthalate), fluoropolymers, or metalized polymeric films, or blends or combinations thereof.

11. The protective composite material of claim 1, wherein a solvent based chloroprene adhesive is disposed between the first layer and the second layer and between the second layer and the third layer.

12. The protective composite material of claim 11, wherein at least one of a polyurethane adhesive or a polychloroprene adhesive is disposed between the polyamide film and the EVOH film.

13. The protective composite material of claim 4, wherein at least one of a polyurethane adhesive or a polychloroprene adhesive is disposed between the EVOH film and the polyethylene film.

14. The protective composite material of claim 1, wherein at least one of the polychloroprene film of the first layer or the third layer is a partially cross-linked polychloroprene film.

15. The protective composite material of claim 1, wherein a polychloroprene adhesive is disposed between the first layer and the second layer.

16. The protective composite material of claim 1, wherein a solvent-based polychloroprene adhesive is disposed between the first layer and the second layer.

17. The protective composite material of claim 4, wherein at least one of the third layer or the barrier layer is a skin-contacting layer.

18. The protective composite material of claim 1, wherein the protective composite material has a surface weight of approximately 465 to approximately 780 g/m².

19. The protective composite material of claim 1, wherein the protective composite material is NFPA 1991 certified compliant.

20. A protective composite material, comprising:
a first layer comprising a polychloroprene film;
a second layer comprising a meta-aramid substrate disposed on the first layer;
a third layer comprising a polychloroprene film disposed adjacent to the second layer, wherein the second layer is disposed between the first layer and the third layer; and
a fourth barrier layer, wherein the fourth barrier layer comprises a polyamide film, an EVOH film, and a polyethylene film wherein a polychloroprene adhesive is disposed between the polyamide film and the EVOH film and a polychloroprene adhesive is disposed between the EVOH film and the polyethylene film.
